(19) United States
(12) Patent Application Publication
(10) Pub. No.: US 2015/0338257 A1
(43) Pub. Date: Nov. 26, 2015

(54) REMOVABLE MEASURING CAP AND METHOD OF USING SAME

(71) Applicants: Mark Fouad, Urbandale, IA (US); Ayad Ayad, Urbandale, IA (US)

(72) Inventors: Mark Fouad, Urbandale, IA (US); Ayad Ayad, Urbandale, IA (US)

(21) Appl. No.: 14/283,357

(22) Filed: May 21, 2014

(51) Int. Cl. G01F 11/26; G01F 11/28; B65D 47/20

(52) U.S. Cl. CPC G01F 11/261; B65D 47/20; G01F 11/282

(57) ABSTRACT

A measuring cap having an upper section rotatably connected to a lower section. The lower section has an opening in a bottom wall for receiving product from a container and the upper section has an opening in the top wall for dispensing product in a predetermined amount. A separating member is connected to the inner surface of a sidewall of the upper section. As the upper section is rotated in relation to the lower section, the separating member scoops and forces product toward and out of the opening in the top wall.

### BACKGROUND OF THE INVENTION

The present invention is directed to a removable cap and more particularly a cap capable of measuring a precise amount.

Caps for measuring an accurate amount of content are known in the art. These caps are complex in their construction, expensive to manufacture, and often their use is limited to a specific container. Measuring caps are helpful in the administration of topical creams and ointments including both prescription and over the counter medications. These caps help to avoid over medication which can create side effects and under medication which is not efficacious. Still there is a need in the art for a measuring cap that addresses the deficiencies in the art.

An objective of the present invention is to provide a measuring cap that has few parts, is easy to manufacture, and costs less.

Another objective of the present invention is to provide a measuring cap that is used repeatedly on varying containers.

These and other objectives will be apparent to those in the art based upon the following written description, drawings and claims.

### SUMMARY OF THE INVENTION

A measuring cap having an upper section rotatably connected to a lower section. The lower section has an opening in a bottom wall for receiving product from a container and the upper section has an opening in the top wall for dispensing product in a predetermined amount. A separating member is connected to the inner surface of a sidewall of the upper section. As the upper section is rotated in relation to the lower section, the separating member scoops and forces product toward and out of the opening in the top wall.

### BRIEF DESCRIPTION OF THE DRAWINGS

FIG. 1 is an exploded perspective view of a measuring cap;

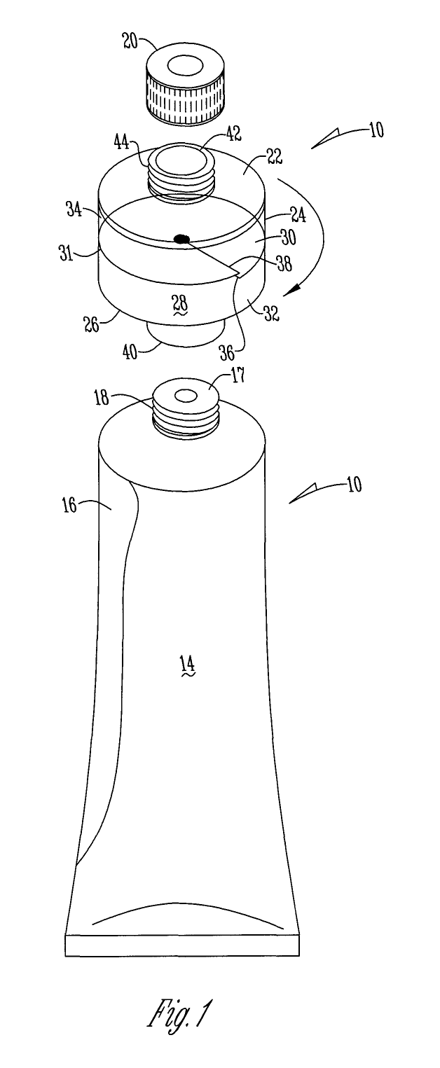

FIG. 2 is an exploded perspective view of a measuring cap; and

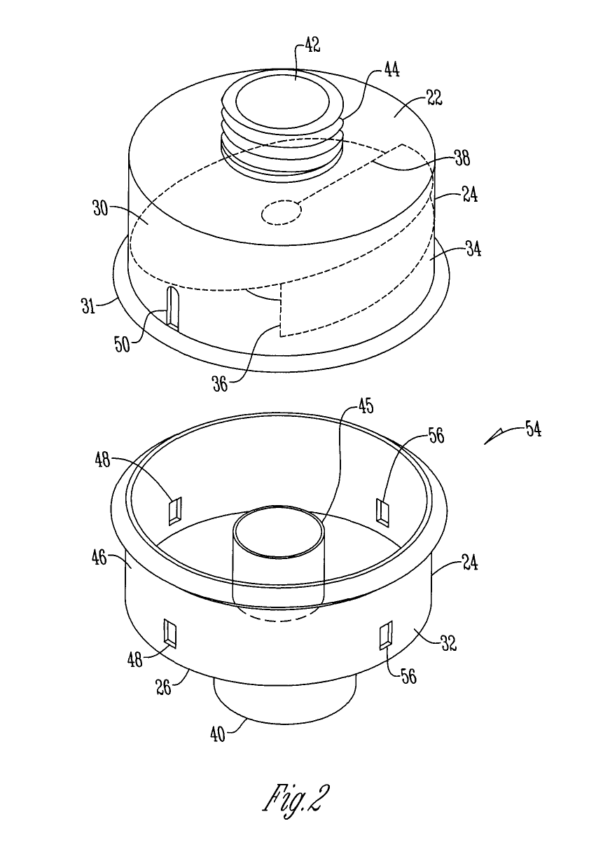

FIG. 3 is a side sectional view of a measuring cap.

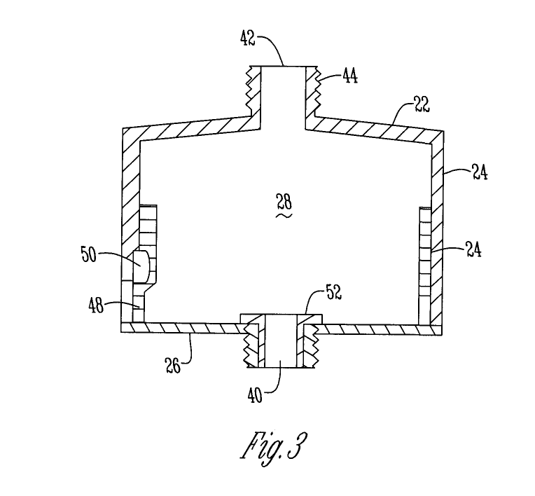

### DETAILED DESCRIPTION OF THE PREFERRED EMBODIMENTS

Referring to the Figures, a measuring cap 10 is used in conjunction with a container 12 that holds a product 14. The product is of any type such as a cream, ointment, food product, paint or the like. Likewise, the container 12 is of any type. By way of example, only the container 12 is a tube having a compartment 16 that stores product 14. At one end the container 12 is an opening or port 17 surrounded by a stem 18. Removably attached to the stem 18 is a cap 20.

The measuring cap 10 has a top wall 22, a sidewall 24 and a bottom wall 26 that form a cavity or compartment 28. The compartment 28 is divided into a first or bottom section 32 and a second or top section 34 wherein the top section 34 is connected to and rotates in relation to the bottom section 32. The top section 34 has a separating member 30 connected adjacent a bottom edge 31. The separation member 30 is of any type and preferably has a first or lower edge 36 and a second or upper edge 38. The outer periphery of the separation member 30 is connected to an inner surface of the sidewall 24 and extends from the first edge 36 to the second edge 38 to create a spiral.

The bottom wall 22 has an opening 40 formed to connect to the stem 18 of the container 12. The upper wall 26 has an opening 42 surrounded by a stem 44 that receives cap 20, or alternatively its own closing cap.

In operation, one removes cap 20 from stem 18 of the container 12 and connects the opening 40 of the measuring cap 10 to the stem 18 of the container 12. The container 12 is then squeezed causing product 14 to flow from compartment 16 through openings 17 and 40 and into compartment 28. Compartment 28 is sized to have a volume consistent with a predetermined amount of product 14. Once compartment 28 is filled with product 14, the upper section 34 is twisted in relation to the lower section 32 causing the separating member 30 to rotate. As the separating member 30 rotates, the lower edge 36 engages product 14 causing product 14 to flow toward the upper edge 38 and creating pressure to dispense product 14 out of compartment 28 through opening 42. The upper section 34 is rotated until most of the product 14 is removed which approximately equals the predetermined amount.

In an alternative embodiment, the bottom section 32 has a tube 45 that extends from compartment 16, through openings 17 and 40, and into compartment 28. On the outer surface 46 of the sidewall 24 of the bottom section 32 are a plurality of protrusions 48. The upper section 34 has a diameter greater than the diameter of the lower section 32 and a sidewall 24 that is greater in length than the sidewall 24 of the lower section 32. The upper section 34 fits over the lower section 32 and has at least one protrusion or slot 50 that interacts with protrusions 48.

In operation, the measuring cap 10 is attached to container 12 and by squeezing the container, product flows from compartment 16 through tube 44 and into compartment 28. To dispense product 14, the upper section 34 is rotated one click. A click is defined as rotation of the upper section 34 in relation to the lower section 32 such that the upper section 34 moves from engagement of at least one protrusion or slot 50 with protrusion 48 to engagement with the next adjacent protrusion 48. As the upper section 34 rotates, based on the spacing of the protrusions and the volume of compartment 28, the separating member 30 engages product and through pressure dispenses a predetermined amount of product through opening 42.

In yet another embodiment, a check valve 52 is placed at opening 40 to prevent flow of fluid from compartment 28 into compartment 16. A counter 54 with indicia 56 is positioned on the outer surface 46 of the bottom section 32 or on the top of the upper section 34. The upper section 34 is threadably connected to the lower section 32. In operation, the measuring cap 10 is attached to the container 12 and the container is squeezed causing product 14 to flow through openings 17 and 40 from compartment 16 to compartment 28 until compartment 28 is filled. Once filled, the upper section 34 is twisted or rotated in relation to the bottom section 32 such that the slot or protrusion 50 disengages from protrusion 48 and reengages with an adjacent protrusion which is defined as one click. One click is equal to dispensing a predetermined amount of product. As the upper section 34 is rotated in relation to the bottom section 36, the top wall 22 presses down on the product 14 and the check valve 52 prevents flow out of opening 40 such that product is forced out through opening 42. The counter 54 keeps track of how many rotations have occurred and the number of predetermined amounts that have been dispensed.

Thus, a measuring cap having flow parts, that is easy to operate and economical to manufacture has been disclosed and, at the very least, all of the objectives have been met.

What is claimed is:

1. A measuring cap for dispensing a predetermined amount of product, comprising:
a first section rotatably connected to a second section to form a compartment;
a separating member connected to a bottom edge of the second section;
an opening on a bottom wall of the first section for receiving product; and
an opening on a top wall of the second section for dispensing product when the second section is rotated in relation to the first section.

2. The cap of claim 1 wherein the separating member has a lower edge, an upper edge, is connected to the inner surface of a sidewall of the second section, and extends from the first edge to the second edge to form a spiral.

3. The cap of claim 1 wherein a tube extends through the opening in the bottom wall.

4. The cap of claim 1 wherein a plurality of protrusions are on an outer surface of a sidewall of the first section.

5. The cap of claim 4 wherein the second section has at least one slot on an inner surface of a sidewall and selectively engages one of the plurality of protrusions.

6. A method of dispensing a predetermined amount of product, comprising the steps of:
attaching a measuring cap to a container that holds product;
squeezing the container to cause product to flow from the container into a compartment of the measuring cap;
rotating an upper section of the measuring cap in relation to a lower section such causing product to flow out of an opening in a top wall of the upper section.

7. The method of claim 6 wherein a slot on an inner surface of a sidewall of the upper section disengages a protrusion on an outer surface of a sidewall and reengages an adjacent protrusion when the upper section is rotated.

8. The method of claim 6 wherein a separating member causes product to flow out of the upper section when the upper section is rotated.

9. A measuring cap for dispensing a predetermined amount of product, comprising:
an upper section having a top wall with an opening and a sidewall that fits over and is rotatably and threadably connected to a lower section having a bottom wall with an opening and a sidewall to form a cavity;
a check valve placed at the opening in the bottom wall to prevent flow from the cavity out of the opening in the bottom wall; and
a plurality of protrusions on an outer surface of the sidewall of the bottom section that selectively engage at least one slot on an inner surface of the sidewall of the upper section.

10. The cap of claim 9 wherein rotation of the upper section from one protrusion to an adjacent protrusion causes disbursement of a predetermined amount of product.

11. The cap of claim 9 further comprising a counter on one of the upper and lower sections.

12. The cap of claim 11 wherein the counter includes indicia associated with the plurality of protrusions.
